(19) United States
(12) Patent Application Publication
(10) Pub. No.: US 2011/0058185 A1
(43) Pub. Date: Mar. 10, 2011

(54) LABEL PRINTING DEVICE AND LABEL PRINTING METHOD

(75) Inventor: Takeshi Arihara, Shizuoka (JP)

(73) Assignee: TOSHIBA TEC KABUSHIKI KAISHA, TOKYO (JP)

(21) Appl. No.: 12/868,969

(22) Filed: Aug. 26, 2010

(30) Foreign Application Priority Data
Sep. 8, 2009 (JP) 2009-207334

(51) Int. Cl. G06K 15/02

(52) U.S. Cl. 358/1.6

(57) ABSTRACT

According to one embodiment, a label printing device includes a reading unit, a communication unit, and a printing unit. The reading unit is configured to read management data. The communication unit is configured to communicate with an external device by Connectionless Communication Protocol communication to acquire from the external device printing data corresponding to the management data. The printing unit is configured to print a label image on a recording medium based on the printing data.

### CROSS-REFERENCE TO RELATED APPLICATIONS

This application is based upon and claims the benefit of priority from Japanese Patent Application No. 2009-207334, filed on Sep. 8, 2009, the entire contents of which is incorporated herein by reference.

### FIELD

Embodiments described herein relate generally to a label printing device and a label printing method which may communicate with an external portable terminal through a communication function such as SNMP (Simple Network Management Protocol).

### BACKGROUND

There has been research for image forming devices which may receive printing data and a command from an external information processing device by using a communication function, and based on the so-received printing data and command, the image forming devices may form an image on a recording medium. For the image forming devices, research has been made to consider the communication security or communication load.

### BRIEF DESCRIPTION OF THE DRAWINGS

FIG. 1 is a block diagram showing an example of a label printing device.

FIG. 2 is a schematic diagram showing an overview of an example of the label printing device.

FIG. 3 is an illustrative diagram illustrating an example of a connection state between peripheral devices and the label printing device.

FIG. 4 is a flowchart showing an example of a scanning process of the label printing device.

FIG. 5 is a flowchart showing an example of a transmission process of printing data of a portable terminal which communicates with the label printing device.

FIG. 6 is a flowchart showing an example of a printing process of the label printing device.

FIG. 7 is a block diagram showing an example of a printer with a scanner.

FIG. 8 is a block diagram showing an example of a portable terminal.

FIG. 9 is a flowchart showing an example of a process of a printer.

FIG. 10 is a flowchart showing an example of a process of a portable terminal.

### DETAILED DESCRIPTION

In general, according to one embodiment, a label printing device includes a reading unit, a communication unit, and a printing unit. The reading unit is configured to read management data. The communication unit is configured to communicate with an external device by Connectionless Communication Protocol communication to acquire from the external device printing data corresponding to the management data. The printing unit is configured to print a label image on a recording medium based on the printing data.

Embodiments will now be described in detail with reference to the drawings.

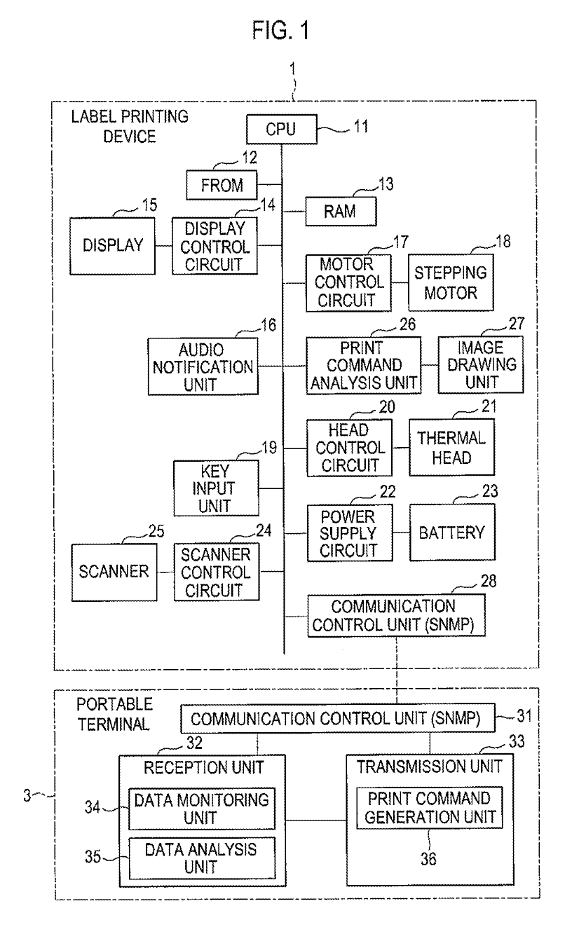

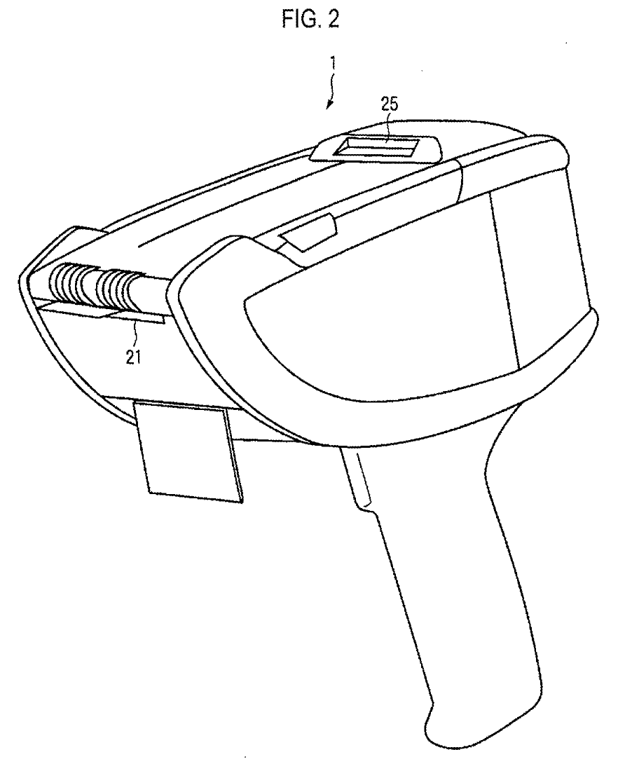

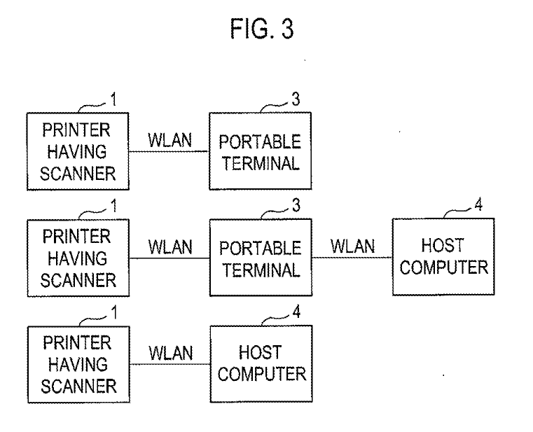

FIG. 1 is a block diagram showing an example of a label printing device according to one embodiment, and FIG. 2 is a schematic diagram showing an overview of an example of the label printing device according to one embodiment. FIG. 3 is an illustrative diagram illustrating an example of a connection state between peripheral devices and the label printing device according to one embodiment.

In one embodiment, as shown in FIGS. 1 and 3, a label printing device 1 may be connected to a portable terminal 3 or a host computer 4 via a network or the like. The label printing device 1 may include a CPU 11 that is configured to control the overall operation, and has function as a history information management unit. The label printing device 1 may further include an FROM 12 that is connected to the CPU 11, and a RAM 13 to store management data indicated by a bar code or the like and printing data or the like corresponding to the management data.

The label printing device 1 may include a display control circuit 14, a display 15 which is configured to display operation information or label information under control of the display control circuit 14, and an audio notification unit 16 (e.g., a speaker or the like) to audibly notify a user or the like that scanning succeeded. The label printing device 1 may further include a motor control circuit 17, a stepping motor 18 whose operation is controlled by the motor control circuit 17, a key input unit 19 with which a user may input operation information or the like, a head control circuit 20 to print a label image on a medium such as a label or the like, a thermal head 21 whose operation is controlled by the head control circuit 20 and which may perform a printing operation on the medium of the label or the like, a power supply circuit 22 which may supply power to each part/unit, a battery 23 which may supply power to the power supply circuit 22, a scanner control circuit 24, and a scanner 25 as a reading unit, which is controlled by the scanner control circuit 24 to read the bar code or the like. The label printing device 1 may further include a communication control unit 28 as a communication unit configured to perform Connectionless Communication Protocol (e.g., SNMP) communication with a portable terminal 3 or the host computer 4 to thereby transmit/receive management data and printing data corresponding to the management data. The above-described elements may be respectively connected to the above-described CPU 11.

For example, the portable terminal 3 may include a communication control unit 31 that uses the SNMP communication, a print command generation unit 36 in a transmission unit 33. The portable terminal 3 may further include a data monitoring unit 34 and a data analysis unit 35 in a reception unit 32.

The label printing device 1 having the above-described configurations may use SNMP communication at the time of transmitting data to the portable terminal 3 or the host computer 4 when printing a reduced price label. In this regard, the exchange between the hosts (the portable terminal 3 or the host computer 4) is required for making an inquiry about PLU information. The label printing device 1 may transmit management data of a bar code or the like read by the scanner 25 to the portable terminal 3 or the host computer 4. The portable terminal 3 or the host computer 4 may generate a print command from the management data, and transmit the generated print command to the label printing device 1. The label printing device 1 may issue a markdown label on which a label image is printed.

Here, when a general communication protocol is used, it is necessary to constantly maintain a connection state for communication between the label printing device 1 and the portable terminal 3 or the host computer 4. This may interfere with other communication or may become the cause of a communication failure.

In one embodiment, TRAP communication of SNMP is used for communication from the label printing device 1, and accordingly it is not necessary to constantly maintain the connection state for communication from the label printing device 1 to the host computer 4. Here, the SNMP TRAP communication is used to manage a network using SNMP, and is used to deliver a status report from a terminal that is to be managed to a management server. This report may be transmitted to the portable terminal 3, the host computer 4, or the like when a pre-designated event is generated or a threshold value is reached in the label printing device 1 for which an SNMP agent is operating.

The label printing device 1 transmits management data that is read by the scanner 25 to the portable terminal 3 or the host computer 4 by the SNMP TRAP communication. Upon receiving the SNMP TRAP communication, the portable terminal 3 or the host computer 4 may generate a print command from the management data. When the print command is transmitted from the host (e.g., the portable terminal 3 or the host computer 4) to the label printing device 1, a connection is established for the first time, communication is performed, and a disconnection is made.

Meanwhile, since SNMP is a kind of UDP (User Datagram Protocol), which does not have a connection concept, the reliability of receiving a reception acknowledgement from the host is not guaranteed. UDP is a protocol which serves as a basis for the Internet standard protocol TCP/IP. In TCP/IP, data is exchanged by a combination of IP of a network layer protocol and either TCP or UDP of the transport layer protocol. TCP starts the communication after establishing a session (connection), but UDP adopts a datagram scheme in which data is sent to a destination without establishing the session (connection). Accordingly, the protocol processing in UDP may be performed at high speed, but the reliability of UDP is relatively low due to the lack of an error correction/retransmission function as provided in TCP. Accordingly, UDP is usually used in a situation where high speed rather than reliability is necessary.

Accordingly, the case where scanning succeeded but its data is not transmitted to the host may not occur frequently. However, since the situation where scanned data may not be transmitted due to an error of UDP, the error may be shown to the user as if a scanning error occurred. The user may then smoothly re-scan. In this way, it is possible to avoid the inconvenience when the label printing device is used to scan a bar code or the like.

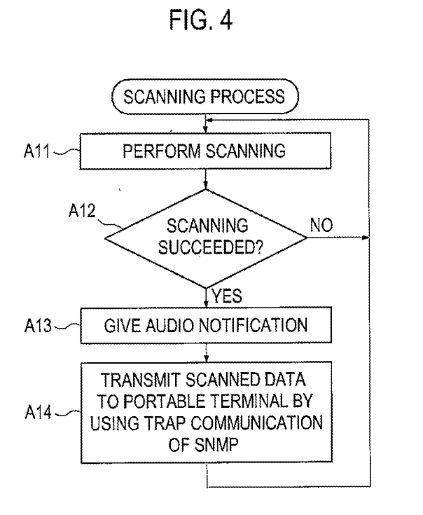

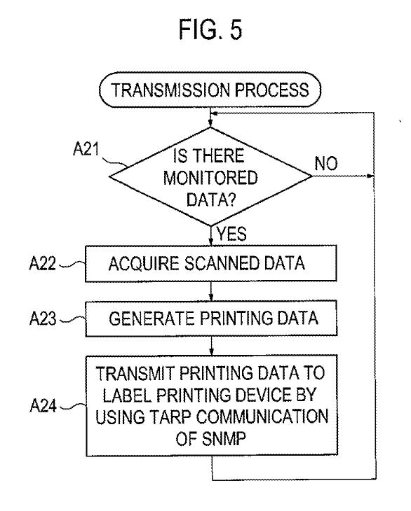

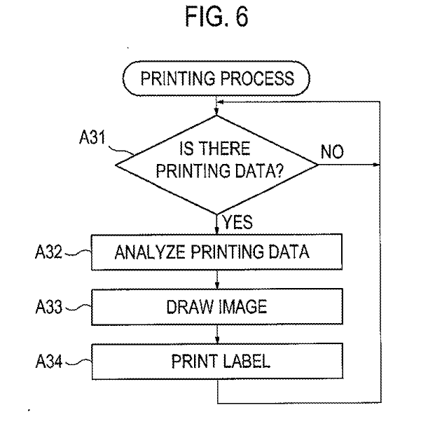

Hereinafter, a printing process of the label printing device 1 having the above-described configuration will be described with reference to the flowcharts. FIG. 4 is a flowchart showing an example of a scanning process of the label printing device. FIG. 5 is a flowchart showing an example of a transmission process of printing data of a portable terminal which communicates with the label printing device. FIG. 6 is a flowchart showing an example of a printing process of the label printing device.

In one embodiment, as shown in the block diagram of FIG. 1, for example, an issuance system may perform label printing using the label printing device 1 and the portable terminal 3 (e.g., PDA) which generates an issuance command. As shown in the flowchart of FIG. 4, the label printing device 1 may scan management data of a bar code or the like by the scanner 25 under control of the CPU 11 (act A11). Upon recognizing that scanning succeeded (act A12), the CPU 11 may control an audio notification unit 16 (such as a speaker or the like) to audibly notify the user that the scanning succeeded (act A13). The CPU 11 may transmit the management data of the scanned bar code or the like to the portable terminal 3 via the communication control unit 28 using the SNMP TRAP communication (act A14). When the portable terminal 3 (e.g., PDA) needs to acquire information of a PLU or the like, the host computer 4 may be further arranged.

An application such as a data monitoring application, a data analysis application, a print command generation application, or the like may be installed in the portable terminal 3 (e.g., PDA). As shown in the flowchart of FIG. 5, the data monitoring unit 34 may monitor the SNMP TRAP communication of the label printing device 1 (act A21). Upon receiving the TRAP communication, the data monitoring unit 34 may acquire scanned data by the data analysis unit 35 (act A22). Next, the print command generation unit 36 of the portable terminal 3 may generate printing data using the acquired scanned data (act A23). The transmission unit 33 and the communication control unit 31 of the terminal device 3 may transmit the printing data generated by the print command generation unit 36 to the label printing device 1 by using an SNMP SET request in the form of a signal indicating a format number, change data, and a label issuance request (act A24). Here, the SET request is one of three SNMP communication methods of the SET request, GET communication, and TRAP communication, and the SET request has a function of setting a desired value in a certain storage region of a peer device which is a communication counterpart. It is desirable to set in advance an address of the portable terminal 3 (which is the communication counterpart) into the label printing device 1.

In one embodiment, a plurality of formats of a label image may be pre-registered in a storage region of the RAM 13 or the like of the label printing device 1, and, for example, a format number, change data, and a label issuance request may be transmitted from the terminal device 3 to the label printing device 1 by using the SNMP SET request. By virtue of one embodiment of the above-described method, it is possible to give instructions on printing data by giving instructions on the specifications of the format of the label image and any changes in the format of the label image, with the use of minimum communication capacity from the terminal device 3 to the label printing device 1.

As shown in the flowchart of FIG. 6, the communication control unit 28 of the label printing device 1 may monitor whether there is an instruction signal indicating that there is printing data from the portable terminal 3 (act A31). When the format number, the change data, and the label issuance request are received as the instruction signal indicating that there is printing data, the print command analysis unit 26, under the control of the CPU 11, may analyze the printing data to specify one of the pre-registered label image formats according to the format number, and change the format according to the change data (act A32). The image drawing unit 27 may generate an image according to the label image format specified and changed by the print command analysis unit 26 (act A33). Next, under the control of the CPU 11, the head control circuit 20 and the thermal head 21 may perform a label printing operation on the label based on the image generated by the image drawing unit 27 (act A34).

As described above, the SNMP communication uses UDP that adopts a datagram scheme in which data is sent to a destination without establishing a session (connection). Thus, protocol processing may be performed at high speed, while the reliability is relatively low due the lack of an error correction/retransmission function. Accordingly, communication may infrequently fail.

However, it is possible to respond to the infrequent communication failure by making a user clearly recognize that he or she should use the method of performing a re-scan at the time when a label is not issued immediately after scanning succeeded. That is, since the possibility of consecutive communication failures is low when the user performs re-scanning, communication by second scanning will succeed. Therefore, communication is performed between the label printing device 1 and the external portable terminal 3, and a subsequent printing process may be smoothly executed.

Accordingly, the label printing device 1 according to one embodiment in which SNMP communication is applied to a communication protocol between the label printing device 1 and the external portable terminal 3 may perform communication by SNMP between the label printing device and the external device. Accordingly, the label printing device 1 is not required to constantly maintain the connection state for bar code scanning, thereby significantly reducing the communication load. In this way, overall, a communication state between the label printing device 1 and the external portable terminal 3 may be dramatically improved.

As described in detail above, in the label printing device 1 according to one embodiment, it is possible to provide a label printing device having a very low communication load since it is not necessary to constantly maintain the connection state for bar code scanning by using SNMP communication as a communication protocol in the communication control unit 28 for an external device such as the portable terminal 3, the host computer 4, or the like.

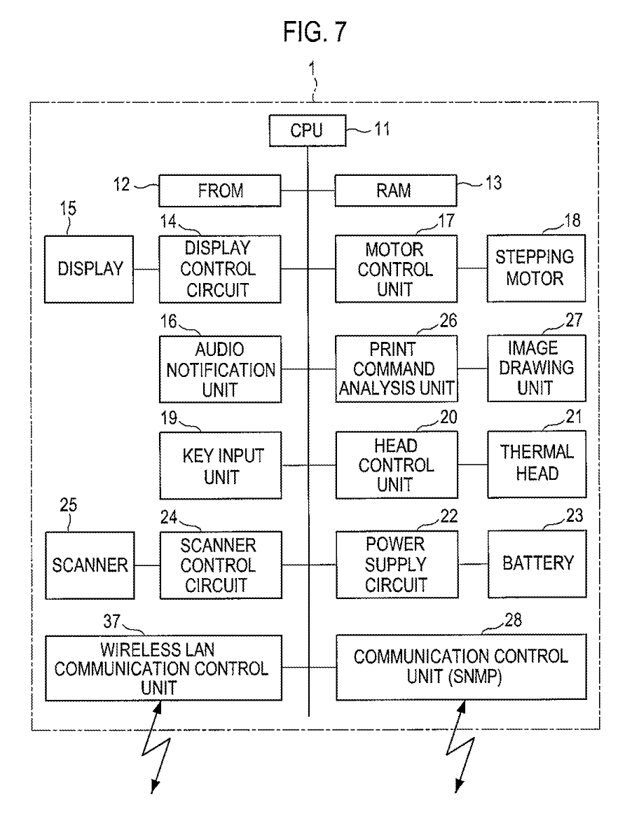

Hereinafter, another embodiment will be described with reference to FIGS. 7 to 10. Same reference numerals will be used to describe the elements that are shared with the above-described embodiment. Detailed descriptions for the above-described shared elements will be omitted.

FIG. 7 is a block diagram showing an example of a printer with a scanner 1. The printer with a scanner 1 may include a CPU 11, an FROM 12, and a RAM 13 to store management data indicated by a bar code or the like and printing data or the like corresponding to the management data. The printer 1 may further include a display control circuit 14 that controls a display 15 configured to display operation information or label information, and include an audio notification unit 16 to audibly notify a user or the like that scanning succeeded. The printer 1 may further include a motor control circuit 17 to control a stepping motor 18 used to carry a recording medium at the time of printing operations, and include a key input unit 19 with which a user may input operation information or the like. The printer 1 may further include a head control circuit 20 to control a thermal head 21 that prints a label image on a medium such as a label or the like, and include a power supply circuit 22 which is connected to a battery 23 to supply power to each part/unit. The printer 1 may further include a scanner control circuit 24 to control a scanner 25 as a reading unit to read the bar code or the like. The printer 1 may further include a communication control unit 28 as a communication unit configured to perform SNMP communication with a portable terminal 3 or the host computer 4 to thereby transmit management data. The above-described elements of the printer 1 may be respectively connected to the CPU 11. The printer 1 may further include a wireless LAN communication control unit 37 that is connected to the CPU 11.

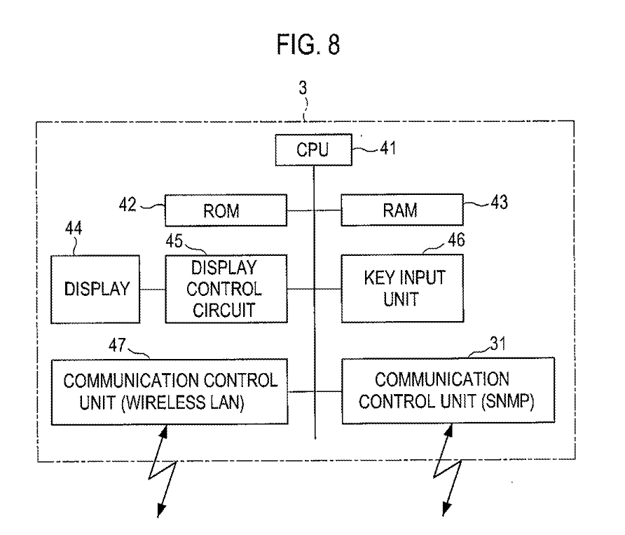

FIG. 8 is a hardware block diagram showing an example of a portable terminal 3. The portable terminal 3 may include a CPU 41, a ROM 42, and a RAM 43 to temporarily store data that are received from the printer 1, data that are generated by the portable terminal 3, or the like. The portable terminal 3 may further include a display control circuit 45 to control a display 44 configured to display operation information or the generated data, and include a key input unit 45 with which a user may input operation information or the like. The portable terminal 3 may further include a wireless LAN communication control unit 47, and a communication control unit 31 used for SNMP communication. The above-described elements of the portable terminal 3 may be respectively connected to the CPU 11.

Herein, a data monitoring unit, a data analysis unit, and a print command generation unit, e.g., which are described with reference to the first embodiment, may be constituted by the CPU 41 and programs that are stored in the ROM 42.

In the second embodiment, the printer 1 may use the SNMP communication to transmit the data scanned by the printer 1 to the portable terminal 3, and then the printer 1 and the portable terminal 3 may exchange data with each other using a wireless LAN.

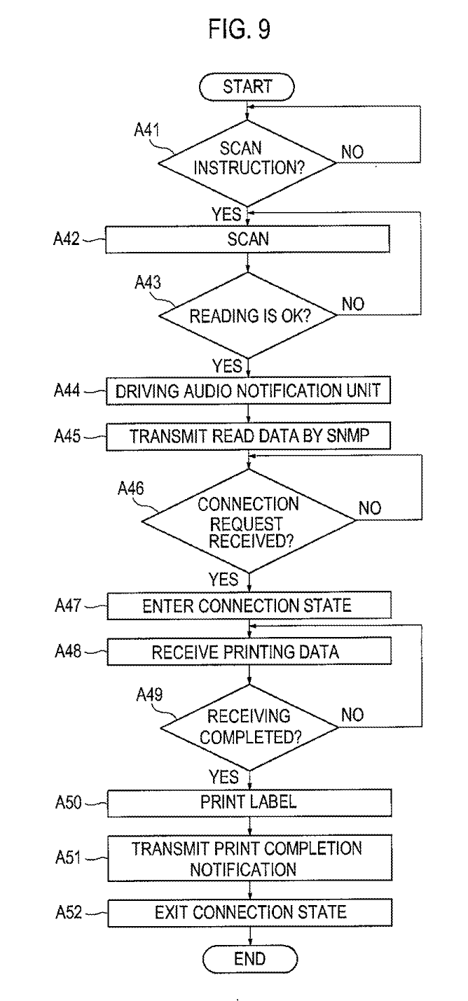

Hereinafter, a process of the printer 1 will be described with reference to FIG. 9. A user may operate the key input unit 19 that is provided with the printer 1 to thereby input a scan instruction (Act A41). The scan control unit 24 may control the scanner 25 to emit laser light to scan a bar code (Act A42). If the scanning of the bar code succeeded (e.g., the bar code reading is OK) (Act A43), the CPU 11 may operate an audio notification unit 16 (Act A44), and transmit the scanned data to the portable terminal 3 using the SNMP TRAP communication (act A45).

The printer 1 may wait for a connection request from the portable terminal 3 to perform data communication by a wireless LAN (act A46). If the printer 1 receives the connection request, the printer 1 may place communication circuits into a connection state (act A47). The printer 1 may receive information on printing data generated by the portable terminal 3 (act A48). If the printer 1 completes the reception of the printing data (act A49), the printer 1 may operate the image drawing unit 27 to present the received printing data as image data, and operate the thermal head 21 to print a label onto a recording medium (not shown) while operating the stepping motor 18 to carry the recording medium (act A50). Upon completing the label printing, the printer 1 may transmit data that notifies the completion of the label printing to the portable terminal 3 (act A51), and exit from the connection state of the wireless LAN (act A51).

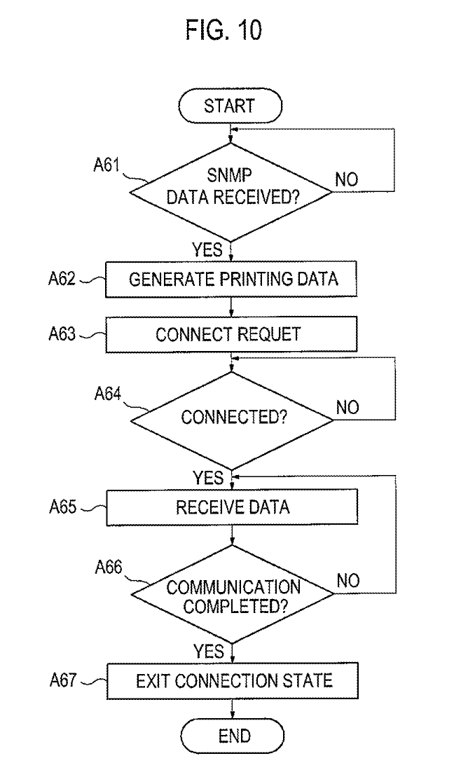

A process of the portable terminal 3 will be described with reference to FIG. 10. The portable terminal 3 may monitor whether SNMP data is received (act A61). Upon receiving the SNMP data, the portable terminal 3 may generate printing data based on the received SNMP data (act A62). To perform communication via the wireless LAN, the portable terminal 3 may make a connection request to the printer 1 (act A63). The portable terminal 3 may determine whether a communication line is placed into a connection state (act A64). Upon determining the connection state, the portable terminal 3 may transmit the generated printing data to the printer 1 (act A65). Upon checking whether printer 1 completed the label printing (act A66) (i.e., the portable terminal 3 receives a label printing completion notification from the printer 1), the portable terminal 3 may exit from the connection state (act A67), and complete the process.

In the second embodiment, the printer 1 may transmit the scanned data using the SNMP communication, which does not require the transition into the connection state, and then wireless LAN communication is placed into the communication state to thereby perform a communication using a wireless LAN. In this way, it is possible to place a communication state into a connection state for a time period, e.g., which is necessary for transmitting the printing data. Further, using a wireless LAN communication may make it possible to communicate at a high speed. Although the SNMP communication and the wireless LAN communication are used in the second embodiment, other wireless communication (e.g., SNMP communication and Bluetooth communication) may be used.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel device and method described herein may be embodied in a variety of other forms; furthermore, various omissions, substitutions and changes in the form of the device and method described herein may be made without departing from the sprit of the inventions. The accompanying claims and their equivalents are intended to cover such forms or modifications as would fall within the scope and spirit of the inventions.

What is claimed is:

1. A label printing device comprising:
a reading unit configured to read management data;
a communication unit configured to communicate with an external device by Connectionless Communication Protocol communication to acquire from the external device printing data corresponding to the management data; and
a printing unit configured to print a label image on a recording medium based on the printing data.

2. The label printing device of claim 1, wherein the Connectionless Communication Protocol is Simple Network Management Protocol (SNMP) communication.

3. The label printing device of claim 2, wherein the communication unit is configured to transmit data to the external device using TRAP communication of SNMP.

4. The label printing device of claim 2, wherein the communication unit is configured to receive data from the external device using a SET request of SNMP.

5. The label printing device of claim 1, further comprising an audio notification unit which is configured to give an audio notification when the management data has been read by the reading unit.

6. The label printing device of claim 1, wherein the reading unit is further configured to scan a bar code to read the management data.

7. The label printing device of claim 1, further comprising a storage device to store a plurality of formats of the label image.

8. The label printing device of claim 4, further comprising a controller configured to analyze the printing data from the external device to thereby specify one of pre-registered label image formats, and wherein the printing unit is further configured to generate the label image according to the specified label image format.

9. The label printing device of claim 3, wherein the TRAP communication of SNMP adopts a UDP.

10. A label printing method using a label printing device having a reading unit configured to read management data, the label printing method comprising:
reading management data through the reading unit;
acquiring from an external device through Connectionless Communication Protocol communication printing data that corresponds to the read management data from the external device; and
printing a label image on a recording medium based on the acquired printing data.

11. The label printing method of claim 10, wherein TRAP communication of Connectionless Communication Protocol is used to transmit data from the label printing device to the external device, and wherein a SET request of Connectionless Communication Protocol is used for the label printing device to receive data from the external device.

12. The label printing method of claim 10, wherein the TRAP communication of Connectionless Communication Protocol adopts a UDP.

13. The label printing method of claim 10, further comprising giving an audio notification when the management data has been read by the reading unit.

14. The label printing method of claim 10, wherein acquiring printing data includes checking whether printing data has been received from the external device; analyzing the printing data to specify one of pre-registered label image formats if the printing data has been received; and generating the label image according to-the label image format.

15. The label printing method of claim 10, further comprising performing a re-scanning, when the label image is not printed immediately after the management data has been read by the reading unit.

16. A printer comprising:
a reading unit configured to read management data;
a first communication unit configured to transmit the management data to an external device by Connectionless Communication Protocol communication;
a second communication unit configured to acquire from the external device printing data corresponding to the management data by using a connection protocol; and
a printing unit configured to print a label image on a recording medium based on the printing data.

17. The printer of claim 16, wherein the first communication unit is configured to transmit data to the external device using TRAP communication of Connectionless Communication Protocol.

18. The printer of claim 16, wherein the second communication unit is further configured to receive a connection request from the external device to enter into a connection state in which to receive the printing data from the external device.

19. The printer of claim 16, wherein if the printing unit completes printing the label image based on the printing data, the second communication unit is configured to transmit data that notifies the completion of the label printing to the external device and exit from the connection state.

20. The printer of claim 16, wherein the connection protocol is a wireless LAN protocol.
